(19) United States
(12) Patent Application Publication
(10) Pub. No.: US 2008/0173379 A1
(43) Pub. Date: Jul. 24, 2008

(54) Rubber compounds and tires

(75) Inventors: Boris Mergell, Hannover (DE); Carla Recker, Hannover (DE); Thomas Fey, Hannover (DE)

Correspondence Address: COLLARD & ROE, P.C., 1077 NORTHERN BOULEVARD, ROSLYN, NY, 11576, US

(73) Assignee: CONTINENTAL AKTIENGESELLSCHAFT

(21) Appl. No.: 12/012,775

(22) Filed: Feb. 5, 2008

Related U.S. Application Data
(63) Continuation of application No. PCT/EP2006/007135, filed on Jul. 20, 2006.

(30) Foreign Application Priority Data
Sep. 17, 2005 (DE) 10 2005 044 456.3

(51) Int. Cl. C08L 7/00; B60C 1/00

(52) U.S. Cl. 152/209.1; 524/575.5

(57) ABSTRACT

The invention relates to a sulphur-vulcanizable rubber compound for the production of tread rubbers for tires, which contains at least one diene rubber, at least one silane coupling agent, at least one filler interacting with the silane coupling agent and further conventional additives. For a reduced loss factor tan at 55° C., the rubber compound contains as the silane coupling agent at least one substance of the following structure: Z-R²X—R¹—Sₙ—R¹—X—R²-Z, where Z is selected from the group comprising: formula (I), wherein R³ is an alkyl group with (1 to 4) carbon atoms, a cycloalkyl group with 5 to 8 carbon atoms or a phenyl radical, where the R³ in a molecule may be the same or different, R⁴ is an alcoxy group with (1 to 4) carbon atoms, a cycloalkoxy group with (5 to 8) carbon atoms or a phenoxy group, where the R⁴ in a molecule may be the same or different, where R¹ and R² are alkylene groups that are different from one another with (1 to 18) carbon atoms, where X is selected from sulphur or oxygen, and with n=2 to 8.

The invention relates to a sulfur-crosslinkable rubber compound for the production of treads for tires, which contains at least one diene rubber, at least one silane coupling agent, at least one filler interacting with the silane coupling agent, and further customary additives. The invention furthermore relates to tires, in particular pneumatic vehicle tires, whose treads are based at least partly on the rubber compound vulcanized with sulfur.

Since the driving properties of a tire are dependent to a large extent on the rubber composition of the tread, the composition of the tread mixture is subject to particularly high requirements. Thus, a variety of tests have been made to vary the tread mixtures with regard to their polymer components and their fillers. For example, the addition of carbon black and/or silica as fillers to the rubber compound is known.

Silica-containing mixture have advantages in the wet slip behavior compared with mixtures which contain only carbon black. Furthermore, the silica-containing tread mixtures impart a low rolling resistance to the tire, which results in reduced fuel consumption. Owing to the increasing fuel prices and the shortage of fossil fuels, attempts are now being made to reduce the rolling resistance of tires even further.

However, the use of silica in rubber compounds leads to a high viscosity of the raw mixtures and hence to poor processability, owing to the large specific hydrophilic surface of the silica. It has long been known that this effect can be counteracted by the use of silane coupling agents, also referred to as reinforcing additives. As a rule, bifunctional organosilanes are used as silane coupling agents. The silane reacts with the surface silanol groups of the silica surface in a first stage with elimination of alcohols. This reaction is referred to as hydrophobization. In the second stage during the vulcanization, the second reactive group of the silane, e.g. an incorporated tetrasulfide group, permits chemical binding to the rubber after cleavage. Accordingly, with silane as the silane coupling agent, a direct chemical bond between filler and rubber is achieved. Owing to the hydrophobization, the organosilane brings about a reduction in the viscosity of unvulcanized silica-containing mixtures and, as a result of the binding to the rubber molecules, a reinforcing effect in the vulcanizates. Mixtures with silane coupling agent are distinguished by a high reversion resistance and a low heat buildup under alternating dynamic stress.

A multiplicity of silane coupling agents is proposed for the coupling between silica and rubber in the prior art. In particular, the organosilane polysulfides having 2 to 8 sulfur atoms in the sulfur bridge are used in the reinforcing of sulfur-vulcanizable rubber compounds. The sulfur bridge is cleaved for binding to the rubber and the binding to the rubber then takes place via the sulfur atoms. Thus, for example, DE 25 36 674 C3 and DE 22 55 577 C3 disclose vulcanizable rubber compounds which contain, as reinforcing additives, organosilanes of the general formula Z-Alk-Sₙ-Alk-Z, in which n is a number from 2 to 6. In order to be able to use both groups Z of a molecule for the coupling between silica and rubber and to enable binding to the rubber to take place at all, at least two sulfur atoms must form the bridge for an organosilane polysulfide effective as a coupling agent.

These said additives advantageously influence the preparation of the rubber compound and the properties of the vulcanizates. In addition, crosslinking without addition of elemental sulfur is possible with such organosilane polysulfides which have 3 or more sulfur atoms in the bridge, since these compounds act as sulfur donors at elevated temperatures.

It is the object of the present invention to provide a sulfur-crosslinkable rubber compound, in particular for the treads of vehicle tires, whose vulcanizates are distinguished by a reduced loss factor tan δ at 55° C.

In the tire industry, in the case of tire tread mixtures, the loss factor tan δ at 55° C. is a measure of the rolling resistance. If the rubber compound having a reduced loss factor tan δ at 55° C. with the abovementioned properties is used for the tread of a pneumatic vehicle tire, the tire has a reduced rolling resistance.

This object is achieved, according to the invention, if the rubber compound comprises, as a silane coupling agent, at least one substance of the following structure:

Z-R²—X—R¹—Sₙ—R¹—X—R²-Z

Z being selected from the group consisting of:

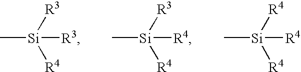

in which R³ is an alkyl group having 1 to 4 carbon atoms, a cycloalkyl group having 5 to 8 carbon atoms or a phenyl radical, it being possible for the R³ in one molecule to be identical or different, R⁴ is an alkoxy group having 1 to 4 carbon atoms, a cycloalkoxy group having 5 to 8 carbon atoms or a phenoxy group, it being possible for the R⁴ in one molecule to be identical or different,
R¹ and R², independently of one another, being alkylene groups having 1 to 18 carbon atoms,
X being selected from sulfur or oxygen, and with n=2 to 8.

Surprisingly, it was found that, by using the abovementioned class of substances as the silane coupling agent, the loss factor tan δ at 55° C. can be even further reduced, which results in a reduction of rolling resistance in the case of tires having a tread comprising the mixture. The spacer between the triethoxysilyl group and the —Sₙ group in the middle of the molecule appears to increase the probability of coupling of the silane coupling agent to the rubber molecules. The coupling efficiency can apparently be increased. The Payne effect, i.e. the increase in the hysteresis by degradation of filler structures, is reduced.

The rubber compounds according to the invention additionally have the advantage of increased hardness at room temperature, which leads to improved handling behavior when used as tire treads. Furthermore, the mixtures show shorter heating times.

For a particularly effective reduction of the rolling resistance, it has proven to be expedient if the rubber compound contains from 3 to 20 phf (=parts by weight per 100 parts by weight of filler interacting with the silane coupling agent) of silane coupling agent. In the case of the dose, it should be taken into account that the molecular weight increases with increasing spacer length without the number of coupling-active groups in the molecule increasing, so that, in the case of molecules having a higher molecular weight, the weight ratio of silane coupling agent to filler must be correspondingly increased.

The X in the silane coupling agent may be, independently of one another, a sulfur or an oxygen atom. It is advantageous if both X in the molecule are sulfur atoms. Alternatively, both X in the molecule may also be oxygen atoms. The latter silane coupling agents can be more easily synthesized.

According to an advantageous further development of the invention, R¹ is a propylene group and R² an alkylene group having 5 to 14 carbon atoms. Owing to the greater space between the triethoxysilyl group and the —S₂ group in the middle of the molecule and the associated growing increase in the hydrophobic moiety in the molecule, the loss factor tan δ at 55° C. can be particularly greatly reduced.

The rubber compound may contain one or more silane coupling agents having the structure as claimed in claim 1. However, the rubber compound may also have further silane coupling agents of a different structure. With the use of at least two different silane coupling agents, positive effects can be achieved with regard to typical desired tire properties.

It has proven to be particularly advantageous if, in addition to the silane coupling agents having the structure as claimed in claim 1, a silane coupling agent of the following structure is also used:

Y—R⁵—Sₘ—R⁵—Y

Y being selected from the group consisting of:

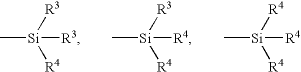

in which R³ is an alkyl group having 1 to 4 carbon atoms, a cycloalkyl group having 5 to 8 carbon atoms or a phenyl radical, it being possible for the R³ in one molecule to be identical or different, R⁴ is an alkoxy group having 1 to 4 carbon atoms, a cycloalkoxy group having 5 to 8 carbon atoms or a phenoxy group, it being possible for the R⁴ in one molecule to be identical or different,
R⁵ being an alkylene group having altogether 1 to 4 carbon atoms, it being possible for the R³ in one molecule to be identical or different, and with m=1 to 8.

These may be, for example, 3,3′-bis(triethoxysilyl-propyl)polysulfides having 2 to 8 sulfur atoms, such as, for example, 3,3′-bis(triethoxysilylpropyl)tetra-sulfide (TESPT). By using this further silane coupling agent, the loss factor tan δ at 0° C., which is a measure for the wet grip in the case of tire treads, can be increased without adversely affecting the loss factor tan δ at 55° C. The conflict between the properties wet grip and rolling resistance, which usually show the opposite behavior, can be resolved in this way.

It has proven to be particularly advantageous with regard to resolving the conflict between rolling resistance and wet grip if

a) (C₂H₅O)₃Si—(CH₂)₃—X—(CH₂)₆—S₂—(CH₂)₆—X—(CH₂)₃—Si(OC₂H₅)₃ and/or

### b) (C₂H₅O)₃Si—(CH₂)₃—X— (CH₂)₁₀—S₂—(CH₂)₆—X—(CH₂)₁₀—

Si(OC₂H₅)₃ preferably having sulfur atoms for both X, is or are used in combination with
c) (C₂H₅)₃Si—(CH₂)₃—Sₘ—(CH₂)₃—Si(OC₂H₅)₃ as silane coupling agents.

The molar ratio of a) and/or b) to c) is preferably from 5:1 to 1:5 mol %, in particular from 3:1 to 1:3 mol %, particularly preferably from 2:1 to 1:2 mol %. The organosilane of the type (C₂H₅O)₃Si—(CH₂)₃—Sₘ—(CH₂)₃—Si(OC₂H₅)₃ used in customary rubber compounds for tire treads is exchanged in the mixtures in molar proportions for (C₂H₅O)₃Si—(CH₂)₃—X— (CH₂)₆—S₂—(CH₂)₆—X—(CH₂)₃—Si(OC₂H₅)₃ and/or (C₂H₅O)₃Si—(CH₂)₃—X—(CH₂)₁₀—S₂—(CH₂)₆—X—(CH₂)₁₀—Si (OC₂H₅)₃.

The sulfur-crosslinkable rubber compound according to the invention contains at least one diene rubber. The diene rubbers include all rubbers having an unsaturated carbon chain which is derived at least partly from conjugated dienes. It is particularly preferable if the diene rubber or the diene rubbers is or are selected from the group consisting of natural rubber (NR), synthetic polyisoprene (IR), polybutadiene (BR) and styrene-butadiene copolymer (SBR). These diene elastomers can be readily processed to give the rubber compound according to the invention and give good tire properties in the vulcanized tires.

The rubber compound may contain polyisoprene (IR, NR) as diene rubber. This may be cis-1,4-polyisoprene as well as 3,4-polyisoprene. However, the use of cis-1,4-polyisoprenes having a cis-1,4 fraction of >90% by weight is preferred. Firstly, such a polyisoprene can be obtained by stereospecific polymerization in solution using Ziegler-Natta catalysts or with the use of finely divided lithium alkyls. Secondly, natural rubber (NR) is such a cis-1,4-polyisoprene and the cis-1,4 fraction in the natural rubber is greater than 99% by weight.

If the rubber compound contains polybutadiene (BR) as the diene rubber, said polybutadiene may be both cis-1,4-polybutadiene and vinylpolybutadiene (10-90% by weight vinyl fraction). Cis-1,4-polybutadiene having a cis-1,4 fraction greater than 90% by weight can be prepared, for example, by solution polymerization in the presence of catalysts of the rare earth type.

The styrene-butadiene copolymer may be a solution-polymerized styrene-butadiene copolymer (S-SBR) having a styrene content, based on the polymer, of about 10 to 45% by weight and a vinyl content (content of 1,2-bonded butadiene, based on the total polymer) of from 10 to 70% by weight, which can be prepared, for example, with the use of lithium alkyls in organic solvent. The S-SBR may also be coupled and/or have modified terminal groups. However, emulsion-polymerized styrene-butadiene copolymer (E-SBR) and mixtures of E-SBR and S-SBR may also be used. The styrene content of the E-SBR is about 15 to 50% by weight, and the types known from the prior art which are obtained by copolymerization of styrene and 1,3-butadiene in aqueous emulsion can be used.

In addition to said diene rubbers, the mixture can, however, also contain other rubber types, such as, for example, styrene-isoprene-butadiene terpolymer, butyl rubber, isoprene-butadiene rubber, halobutyl rubber or ethylene-propylene-diene rubber (EPDM).

The rubber compound according to the invention contains at least one filler interacting with the silane coupling agent. Said filler may comprise polar fillers, such as aluminas or aluminum hydroxides, phyllosilicates, aluminosilicates or carbon blacks doped with silica. However, silica is preferably used as filler interacting with the silane coupling agent. A finely divided, precipitated silica which has a nitrogen surface area (BET surface area) (according to DIN 66131 and 66132) of from 35 to 350 m²/g, preferably from 145 to 270 m²/g, and a CTAB surface area (according to ASTM D 3765) of from 30 to 350 m²/g, preferably from 120 to 295 m²/g, is preferably used. Such silicas lead, for example, in rubber compounds for tire treads, to particularly good physical properties of the vulcanizates. In addition, there may be advantages in the processing of the mixture owing to a reduction of the mixing time in combination with constant product properties, which lead to better productivity. Silicas which may be used are therefore, for example, both those of the type VN3 (trade name) from Degussa and highly dispersible silicas, so-called HD silicas (e.g. Ultrasil 7000 from Degussa). So-called HDRS types (high dispersible reactive silica) can also be used.

The interacting filler is preferably used in amounts of from 10 to 140 phr in the rubber compound.

The phr data used in this document (parts per hundred parts of rubber by weight) are the quantity data customary in the rubber industry for formulations of mixtures. The dose in parts by weight of the individual substances is always based on 100 parts by weight of the total mass of all rubbers present in the mixture.

In addition to the filler interacting with the silane coupling agent, the rubber compound may contain further fillers, for example carbon black. The carbon blacks which may be used preferably have the following characteristics: DBP number (according to ASTM D 2414) from 90 to 200 ml/100 g, CTAB number (according to ASTM D 3765) from 80 to 170 m²/g and iodine adsorption number (according to ASTM D 1510) from 10 to 250 g/kg.

Apart from said substances, the rubber compound may also comprise other additives, such as, for example, plasticizers (e.g. aromatic, naphthenic or paraffinic mineral oil plasticizers, MES (mild extraction solvate), TDAE (treated distillate aromatic extract), RAE (residual aromatic extract), rapeseed oil or liquid polymers, for example liquid butadiene-styrene random copolymers or liquid polybutadiene).

Furthermore, the rubber compound according to the invention may contain further customary additives in customary parts by weight. These additives include antiaging agents, such as, for example, N-phenyl-N′-(1,3-dimethylbutyl)-p-phenylenediamine (6PPD), N-isopropyl-N′-phenyl-p-phenylenediamine (IPPD), 2,2,4-trimethyl-1,2-dihydroquinoline (TMQ) and other substances as are known, for example, from J. Schnetger, Lexikon der Kautschuktechnik [Lexikon of Rubber Technology], 2nd edition, Hüthig Buch Verlag, Heidelberg, 1991, pages 42-48, activators, such as, for example, zinc oxide and fatty acids (e.g. stearic acid), waxes, resins and mastication auxiliaries, such as, for example, 2,2′-dibenzamidodiphenyl disulfide (DBD).

The vulcanization is carried out in the presence of sulfur or sulfur donors, it being possible for some sulfur donors simultaneously to act as vulcanization accelerators. Sulfur or sulfur donors is or are added together with the accelerators to the rubber compound in the last mixing steps in the amounts customary for the person skilled in the art (from 0.4 to 6 phr of sulfur, preferably in amounts of from 1.0 to 2.5 phr).

Furthermore, the rubber compound may contain vulcanization-influencing substances, such as vulcanization accelerators, vulcanization retardants and vulcanization activators, in customary amounts for controlling the required time and/or the required temperature of the vulcanization and for improving the vulcanizate properties. The vulcanization accelerators can be chosen, for example, from the following groups of accelerators: thiazole accelerators, such as, for example, 2-mercaptobenzothiazole, sulfenamide accelerators, such as, for example, benzothiazyl-2-cyclohexylsulfenamide (CBS), guanidine accelerators, such as, for example, N,N′-diphenylguanidine (DPG), dithiocarbamate accelerators, such as, for example, zinc dibenzyldithiocarbamate, disulfides and dithiophosphates. The accelerators can also be used in combination with one another, it being possible for synergistic effects to result.

The rubber compound according to the invention is prepared in a conventional manner, as a rule a base mixture which contains all constituents with the exception of the vulcanization system first being prepared in one or more mixing stage(s) and the final mixture subsequently being produced by addition of the vulcanization system. The mixture is then further processed, for example by an extrusion process, and brought into the appropriate form. The rubber compound can be used, for example, for various tire components, for example as a mixture in the core and/or belt region or as crescent-shaped emergency insert in the side wall region. Preferably, however, the mixture is used as treads and is brought into the form of a tread for this purpose. A tread mixture blank produced in this manner is applied, as known, in the production of the tire blank, in particular of the pneumatic vehicle tire blank. However, the tread can also be wound onto a tire blank, which already contains all tire parts except for the tread, in the form of a narrow strip of rubber compound.

After the vulcanization, the vulcanizates have a reduced loss factor tan δ at 55° C. Pneumatic vehicle tires having a tread comprising such a mixture have a reduced rolling resistance.

The invention is now to be explained in more detail with reference to comparative and working examples which are summarized in the tables 1.

In the case of all mixture examples contained in table 1, the stated quantity data are parts by weight which are based on 100 parts by weight of total rubber (phr). The comparative mixture is characterized by C and the mixtures according to the invention are characterized by I. The mixtures in table 1 differ only in the type and amount of the silane coupling agents used, the other constituents of the mixture remaining unchanged.

The mixture was prepared under customary conditions in two stages in a laboratory tangential mixer. The reaction times until the relative degrees of crosslinking of 5 and 90% (t₅, t₉₀) were reached were determined using a rotorless vulcameter (MDR=moving disc rheometer) according to DIN 53 529. Test specimens were produced from all mixtures by optimum vulcanization under pressure at 160° C., and material properties typical for the rubber industry were determined with these test specimens using the test methods stated below.
Shore A hardness at room temperature and 70° C. according to DIN 53 505
resilience at room temperature and 70° C. according to DIN 53 512
tensile strength at room temperature according to DIN 53 504
elongation at break at room temperature according to DIN 53 504
stress values at 50, 100, 200 and 300% elongation at room temperature according to DIN 53 504
fracture energy density determined in the tensile test according to DIN 53 504, the fracture energy density being the work required to fracture, based on the volume of the sample
dynamic modulus of elasticity E′ at 8% dynamic deformation amplitude according to DIN 53 513 from measurement at constant temperature of 55° C. and a predeformation of 20% in compression with 10 Hz dynamic deformation frequency
dynamic modulus of elasticity E′ at −10° C. DIN 53 513 from measurement with constant deformation amplitude of 0.2% at 10% predeformation in compression with 10 Hz dynamic deformation frequency
loss factor tan δ at 0 and 55° C. according to DIN 53 513 from measurement with constant deformation amplitude of 0.2% at 10% predeformation in compression with 10 Hz dynamic deformation frequency
abrasion at room temperature according to DIN 53516.

TABLE 1

| | Unit | 1(C) | 2(I) | 3(I) | 4(I) | 5(I) |
|---|---|---|---|---|---|---|
| Constituents | | | | | | |
| BR^{a} | phr | 23 | 23 | 23 | 23 | 23 |
| S-SBR^{b} | phr | 77 | 77 | 77 | 77 | 77 |
| Silica^{c} | phr | 95 | 95 | 95 | 95 | 95 |
| Plasticizer oil | phr | 35 | 35 | 35 | 35 | 35 |
| Antiaging agent | phr | 4 | 4 | 4 | 4 | 4 |
| Antiozone wax | phr | 2 | 2 | 2 | 2 | 2 |
| Zinc oxide | phr | 2.5 | 2.5 | 2.5 | 2.5 | 2.5 |
| Stearic acid | phr | 2.5 | 2.5 | 2.5 | 2.5 | 2.5 |
| Silane coupling | phr | — | 12.03 | — | 4.01 | — |
| agent A^{d} | | | | | | |
| Silane coupling | phr | — | — | 13.94 | — | 4.65 |
| agent B^{e} | | | | | | |
| Silane coupling | phr | 8.08 | — | — | 5.38 | 5.38 |
| agent C^{f} | | | | | | |
| DPG | phr | 2 | 2 | 2 | 2 | 2 |
| CBS | phr | 2 | 2 | 2 | 2 | 2 |
| Sulfur | phr | 2 | 2 | 2 | 2 | 2 |
| Properties | | | | | | |
| t₅ | min | 1.58 | 1.19 | 0.72 | 1.41 | 1.34 |
| t₉₀ | min | 23.31 | 14.59 | 17.79 | 15.65 | 16.26 |
| Hardness at RT | Shore A | 73.6 | 77.1 | 74.2 | 74.7 | 74.6 |
| Hardness at 70° C. | Shore A | 71 | 74.9 | 71.3 | 72.6 | 71.8 |
| Resilience at RT | % | 24.7 | 29 | 29.8 | 26 | 26.3 |
| Resilience at 70° C. | % | 43.6 | 46.9 | 48.2 | 46 | 47.5 |
| (Resilience 70° C. − resilience | — | 18.9 | 17.9 | 18.4 | 20 | 21.2 |
| RT) | | | | | | |
| Tensile strength | MPa | 14.6 | 13 | 14.8 | 14.2 | 15.1 |
| at RT | | | | | | |
| Elongation at | % | 428 | 362 | 422 | 407 | 422 |
| break at RT | | | | | | |
| Stress value 50% | MPa | 1.71 | 2.13 | 1.7 | 1.81 | 1.79 |
| Stress value 100% | MPa | 3.04 | 3.64 | 2.87 | 3.21 | 3.18 |
| Stress value 200% | MPa | 6.1 | 7.02 | 6.13 | 6.43 | 6.48 |
| Stress value 300% | MPa | 10.21 | 11.44 | 10.52 | 10.72 | 10.87 |
| Fracture energy | J/cm³ | 26.3 | 20.9 | 25.8 | 24.6 | 26.9 |
| density | | | | | | |
| E′ 8% | MPa | 6.454 | 7.918 | 6.476 | 6.669 | 6.702 |
| E′ −10° C. | MPa | 88.442 | 101.088 | 74.542 | 72.662 | 77.344 |
| tan δ 0° C. | — | 0.414 | 0.373 | 0.369 | 0.429 | 0.417 |
| tan δ 55° C. | — | 0.189 | 0.157 | 0.158 | 0.179 | 0.173 |
| (tan δ 0° C. − tan δ | — | 0.225 | 0.216 | 0.211 | 0.250 | 0.244 |
| 55° C.) | | | | | | |
| Abrasion | mm³ | 125.76 | 119.98 | 136.06 | 129.88 | 129.47 |

^{a}High-cis polybutadiene
^{b}Solution-polymerized styrene-butadiene copolymer, styrene content: 21% by weight, vinyl fraction 61%, terminal group-modified and tin-coupled
^{c}Ultrasil ® VN3, from Degussa, Germany
^{d}C₂H₅O)₃Si—(CH₂)₃—S—(CH₂)₆—S₂—(CH₂)₆—S—(CH₂)₃—Si(OC₂H₅)₃
^{e}C₂H₅O)₃Si—(CH₂)₃—S—(CH₂)₁₀—S₂—(CH₂)₆—S—(CH₂)₁₀—Si(OC₂H₅)₃
^{f}C₂H₅O)₃Si—(CH₂)₃—S₂—(CH₂)₃—Si(OC₂H₅)₃

From table 1, it is evident that, by using the special silane coupling agents (mixtures 2 to 5), the loss factor tan δ at 55° C. can be surprisingly reduced in comparison with mixture 1 comprising a conventional silane coupling agent, which is equivalent to a reduction of the rolling resistance in the case of tire tread mixtures. The increased resilience at 70° C. too is an indication of reduced rolling resistance. In addition, in the case of the mixtures 2 to 5, it is found that they have slightly improved handling as a tire tread mixture since the hardness at room temperature and the E′ at 8%, which are an indication of the handling, are increased. Furthermore, the heating time t₉₀ is shortened in the case of the mixtures according to the invention.

If the silane coupling agents A or B are combined with the silane coupling agent C (mixtures 4 and 5), the wet grip, measured on the basis of the loss factor tan δ at 0° C. (higher loss factor tan δ at 0° C.=improved wet grip), can additionally be brought to a higher level in comparison with the mixtures 2 and 3. The conflict between rolling resistance and wet grip is thus mitigated. The mixtures 4 and 5 are also distinguished by an improved grip on ice, evident from the reduced E′ at −10° C.

1. A sulfur-crosslinkable rubber compound for the production of treads for tires which contains at least one diene rubber, at least one silane coupling agent, at least one filler interacting with the silane coupling agent, and further customary additives,
wherein
it comprises, as the silane coupling agent, at least one substance of the following structure:
Z-R²—X—R¹—Sₙ—R¹—X—R²-Z
in which Z is selected from the group consisting of: 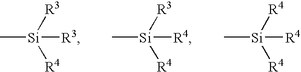
in which R³ is an alkyl group having 1 to 4 carbon atoms, a cycloalkyl group having 5 to 8 carbon atoms or a phenyl radical, it being possible for the R³ in one molecule to be identical or different, R⁴ is an alkoxy group having 1 to 4 carbon atoms, a cycloalkoxy group having 5 to 8 carbon atoms or a phenoxy group, it being possible for the R⁴ in one molecule to be identical or different,
R¹ and R², independently of one another, being alkylene groups having 1 to 18 carbon atoms,
X being selected from sulfur or oxygen,
and with n=2 to 8.

2. The rubber compound as claimed in claim 1, wherein it contains from 3 to 20 phf (parts by weight per 100 parts by weight of the filler interacting with the silane coupling agent) of silane coupling agent.

3. The rubber compound as claimed in claim 1, wherein the X in the silane coupling agent are sulfur atoms.

4. The rubber compound as claimed in claim 1, wherein the X in the silane coupling agent are oxygen atoms.

5. The rubber compound as claimed in claim 1, wherein R¹ is a propylene group and R² an alkylene group having 5 to 14 carbon atoms.

6. The rubber compound as claimed in claim 1, wherein it contains at least two different silane coupling agents.

7. The rubber compound as claimed in claim 6, wherein it contains, as a further silane coupling agent, a substance of the following structure:
Y—R⁵—Sₘ—R⁵—Y
in which Y is selected from the group consisting of: 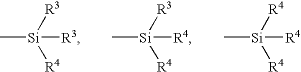
in which R³ is an alkyl group having 1 to 4 carbon atoms, a cycloalkyl group having 5 to 8 carbon atoms or a phenyl radical, it being possible for the R³ in one molecule to be identical or different, R⁴ is an alkoxy group having 1 to 4 carbon atoms, a cycloalkoxy group having 5 to 8 carbon atoms a phenoxy group, it being possible for the R⁴ in one molecule to be identical or different,
R⁵ being an alkylene group having altogether 1 to 4 carbon atoms, it being possible for the R¹ in one molecule to be identical or different,
and with m=1 to 8.

8. The rubber compound as claimed in claim 7, wherein it contains, as silane coupling agents, a) (C₂H₅O)₃Si—(CH₂)₃—X—(CH₂)₆—S₂—(CH₂)₆—X—(CH₂)₃—Si(OC₂H₅)₃ and/or b) (C₂H₅O)₃Si—(CH₂)₃—X—(CH₂)₁₀—S₂—(CH₂)₆—X—(CH₂)₁₀—Si(OC₂H₅)₃ in combination with c) (C₂H₅O)₃Si—(CH₂)₃—Sₘ—(CH₂)₃—Si(OC₂H₅)₃.

9. The rubber compound as claimed in claim 8, wherein the molar ratio of a) and/or b) to c) is from 5:1 to 1:5 mol %.

10. The rubber compound as claimed in claim 9, wherein the molar ratio of a) and/or b) to c) is from 3:1 to 1:3, preferably from 2:1 to 1:2 mol %.

11. The rubber compound as claimed in claim 1, wherein the filler interacting with the silane coupling agent is silica.

12. The rubber compound as claimed in claim 1, wherein it contains from 10 to 140 phr (parts by weight per 100 parts by weight of the total rubber components) of filler interacting with the silane coupling agent.

13. A tire, in particular pneumatic vehicle tire, whose tread is at least partly based on a sulfur-vulcanized rubber compound as claimed in claim 1.
